(19) United States
(12) Patent Application Publication
(10) Pub. No.: US 2019/0102686 A1
(43) Pub. Date: Apr. 4, 2019

(54) SELF-LEARNING FOR AUTOMATED PLANOGRAM COMPLIANCE

(71) Applicant: Intel Corporation, Santa Clara, CA (US)

(72) Inventors: Shao-Wen Yang, San Jose, CA (US); Siew Wen Chin, Penang (MY); Addicam V. Sanjay, Gilbert, AZ (US); Jose A. Avalos, Chandler, AZ (US); Joe Jensen, Chandler, AZ (US); Michael Millsap, Chandler, AZ (US); Daniel Gutwein, Mesa, AZ (US)

(21) Appl. No.: 15/721,283

(22) Filed: Sep. 29, 2017

(51) Int. Cl. G06N 5/04; G06N 99/00; G06Q 10/08

(52) U.S. Cl. CPC G06N 5/04; G06Q 10/087; G06N 99/005

(57) ABSTRACT

A system includes a self-learning module for creating a self-learned planogram based on images of shelving units at a location and shelving unit tracking. The self-learned planogram includes shelving unit locations for the shelving units. The system also includes a training module for training the merchandise tracking model based on merchandise-shelving unit clustering. The merchandise-shelving unit clustering is based on the self-learned planogram and sensor readings received from sensors at the location. The sensor readings are associated with items at the location. The system further includes a tracking module for tracking and storing locations of the items based on the sensor readings and the merchandise tracking model. The system also includes a planogram compliance module for determining planogram compliance based on comparing the self-learned planogram to the item locations. The system identities actionable insights based on the planogram compliance and additionally includes a display device to present the actionable insights.

### TECHNICAL FIELD

Embodiments described herein pertain in general to placement of items in a physical location based on a planogram and in particular to automating planogram compliance based on self-learning.

### BACKGROUND

A planogram is a visual representation of items at a location, such as, for example, products at a store. For instance, planograms are visual representations that indicate placement of retail products in stores or on store shelves. A planogram is a schematic that not only shows a layout of merchandise departments within a store, but also the aisles and shelves where items may be found. That is, a planogram defines where and in what quantity products are to be placed on a shelving unit. Planogram compliance determines if products are placed on one or more shelving units according to a plan or design.

Conventional planogram compliance solutions include vision-based and radio-frequency identification (RFID)-based methods. These conventional solutions are labor-intensive. For instance_{;} traditional vision-based methods are labor-intensive because they require personnel at a location (e.g., staff at a store) to take pictures of items on shelves at the location on a regular basis. With such vision-based methods, the interval may range from a couple of hours to days, depending on the turnover rate of items (e.g., merchandise items) at the location. Existing RFID-based methods require attachment of RFID tags to merchandise items. For instance, existing RFID-based methods require attachment of RFID tags (e.g., passive RFID tags) that are thin enough to be readily integrated into retail logistics by being attached to merchandise.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts an example planogram, according to an embodiment;

FIG. 2 is a block diagram and flowchart illustrating a system and method for automated planogram compliance, according to embodiments;

FIG. 3 illustrates an example deployment of sensors at a store location, according to an embodiment;

FIG. 4A is an example panorama image of items on shelving units at a store location, according to an embodiment;

FIG. 4B depicts example shelving unit tracking results as an occupancy global projection of the shelving units of FIG. 4A, according to an embodiment;

FIG. 5 illustrates example merchandise clustering results that associate merchandise items to shelving units, according to an embodiment;

FIG, 6 illustrates an domain topology for respective internet-of-things (IoT) networks coupled through links to respective gateways, according to an example;

FIG. 7 illustrates a cloud computing network in communication with a mesh network of IoT devices operating as a fog device at the edge of the cloud computing network, according to an example;

FIG, 8 illustrates a block diagram of a network illustrating communications among a number of IoT devices, according to an example;

FIG. 9 illustrates a block diagram for an example IoT processing system architecture upon which any one or more of the techniques (e.g., operations, processes, methods, and methodologies) discussed herein may be performed, according to an example; and

FIG. 10 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art, that the present disclosure may be practiced without these specific details.

Known planogram compliance solutions do not include the ability to perform sensor-based item tracking to provide users with actionable insights regarding items at a location merchandise items at a store) that do not comply with a planogram. Existing planogram compliance solutions are labor-intensive in that they require physical placement of RFID tags or programmable strips on merchandise items or shelves. For instance, a known planogram compliance solution employs a programmable strip-based method that requires use of physical strips placed on shelves (e.g., in shelf channels). Such programmable strip-based methods seek to reduce reset times for shelves and potentially reduce out of stock (OoS) levels for merchandise items on shelves. However, these programmable strip-based methods are labor-intensive because they require personnel to place programmable strips on shelves (e.g., by inserting programmable strips into shelf channels). Such programmable strips may be implemented as electronic displays (e.g., light-emitting diode/LED displays) that are affixed to shelving units. Such electronic displays may be used to display merchandise information (e.g., price, description, inventory status). Other known planogram compliance solutions include inventory based methods that maintain a product log at a checkout point (e.g., a store cash register, point of sale/POS station, or self-checkout station) and work with the assumption that if a product is selected, it will need to be replaced at the same spot in a store. Further, known programmable strip-based methods and inventory-based methods are passive. Such known passive planogram compliance solutions are unable to deal with merchandise that is out of place (i.e., out of place problems).

Some conventional solutions such as vision-based methods (e.g., Amazon Go) may be robust against changes of planograms. However, implementing such conventional solutions may be time consuming. For example, with known vision-based methods, there are significant recurring labor efforts to take pictures of individual shelves from time to time. Also, for example, known vision-based methods only work if a sufficient visual appearance may be captured; the folding and stacking nature of certain merchandise items (e.g., apparel items) limits the usefulness of such vision-based methods.

Other conventional planogram compliance solutions, such as MD-based methods, are vulnerable to planogram changes resulting from movement of shelving units. Such movement may introduce signal level data variation and may degrade significantly. In addition, with known RFID-based methods that are based on supervised machine learning (e.g., random forests), training data must be labeled. With such known RFID methods, frequent movement of shelving units require relatively large labor efforts.

Consequently, issues with known planogram compliance solutions include being labor-intensive and being unable to work with certain types of items (e.g., folded or stacked merchandise on moveable shelving units). Hence, to solve the above-noted issues and problems with known solutions, embodiments optimize planogram compliance by automating training of a merchandise tracking model and using that model to automate planogram compliance for a self-learned planogram.

As used herein, in certain embodiments, the term “planogram” refers to a visual representation that indicates the placement of retail products in a store or on a store shelf. A planogram is a schematic that not only shows the layout of merchandise departments within a store, but also the aisles and shelves where items may be found.

As used herein, the term “store” refers to a physical location where products or services are offered to visitors. For example a store may be a real-world shopping venue (e.g., a brick-and-mortar store) where merchandise items are offered to shoppers. A visitor present at a store is at the real-world shopping venue in person. For example, a person walking through departments and aisles of a store is a visitor to a real-world shopping venue who is present at the store. As another example, a person testing items in an outdoor market is present at a store. Websites with online stores are not real-world shopping venues. Thus, a person using a desktop computer, laptop computer, smart phone, or tablet device at the person's residence to shop for products by accessing a webpage is not present in real-world shopping venue. Thus, as used herein, a “store” refers to a real-world shopping venue that may be a brick-and-mortar store, a retail store, a department or section within a store, an area of an airport where products are sold (e.g., a duty free shop), a public transit station, a retail kiosk or stand, a music or sports venue where merchandise is sold, a museum gift shop, or any other customer-accessible physical location where products or services are offered to customers.

One goal of planogram compliance is to have the correct product, in the proper place, in the right quantity, at the correct price, and at the right time. Additionally, planograms help create a uniform store appearance, which is important for retailers operating from multiple locations (e.g., chain stores). That is, a planogram defines where and in what quantity products are placed on a shelving unit.

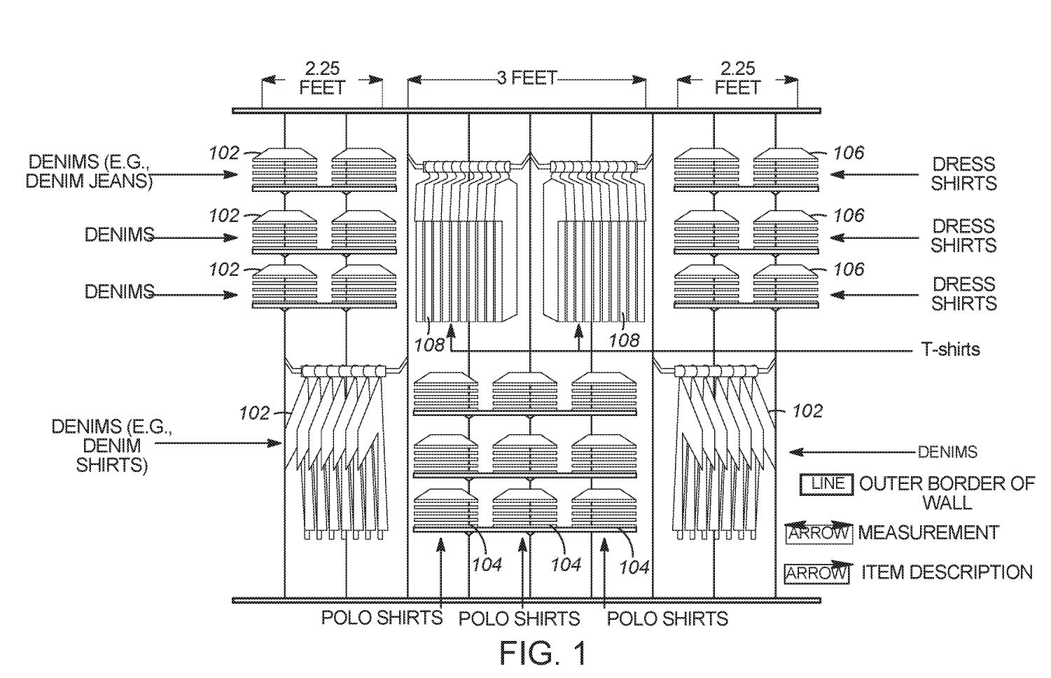

An example planogram is illustrated in FIG. 1. As shown, the planogram indicates dimensions of an example shelving unit and desired placement of items (e.g., apparel items in the example of FIG. 1) in locations within the shelving unit. In FIG. 1, the planogram shows desired placement of denim items 102, polo shirts 104, dress shirts 106, and t-shirts 108.

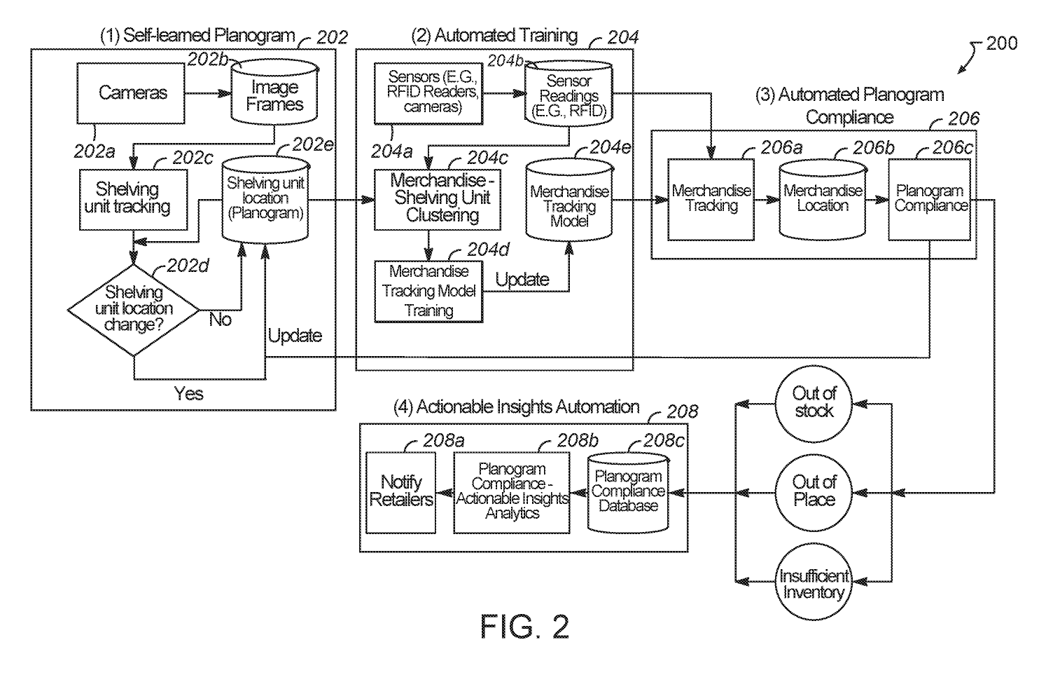

Planogram compliance determines if items (e.g., merchandise items or products) are placed on one or more shelving units by design. Systems and methods for automated planogram compliance disclosed herein cover all aspects of planogram compliance and address the problem of lost sales caused by insufficient inventory levels, out-of-stock (OoS) and out of place items (e.g., misplaced merchandise items in the wrong department or shelving unit), while minimizing the need for human intervention. A planogram and the configuration of shelving units (e.g., shelf locations and layouts) may change over time. For example, due to seasonal changes, promotional changes, or merchandise suppliers paying for premium shelf space, a shelving unit and desired placement of items in locations within the shelving unit may periodically change. Embodiments described herein for automated planogram compliance accommodate shelving changes and changes in product locations by creating and updating a self-learned planogram, as described below with reference to FIG. 2.

A key prerequisite to planogram compliance is location understanding for almost everything at a location (e.g., a store), including people, merchandise items, and shelving units (e.g., the furniture). The ever-changing nature of a planogram makes planogram compliance particularly challenging. This is because change in shelving unit configuration and location, and changes in locations of items on the shelving units, is inevitable by design as a means for retailers to improve sales by showing the right products at the right time at the right location. For instance, seasonal changes in clothing and product offerings (e.g., items related to holiday promotions, back to school items, and seasonal clothing for spring, summer, fall, and winter) cause changes to departments, shelving unit configurations, and merchandise items being offered for sale.

Systems and methods described herein implement a multimodal framework that uses machine learning techniques for planogram compliance inference with precision location understanding. In particular, some embodiments employ supervised machine learning techniques in a self-learning system that minimizes labor costs by automating training data collection for various supervised machine learning stages in the multimodal framework.

Certain embodiments include a self-learning system for automated planogram compliance. Some embodiments use multimodality to eliminate the need of recurring labor efforts, such as those required by known RFID-based methods, for fine-grained location tracking of merchandise items to automatically generate training data for RFID merchandise tracking. For example, such embodiments perform location tracking of RFID-tagged merchandise items and generate training data sets automatically for RFID. Certain embodiments use computer vision to track shelving units' whereabouts. This is in contrast to known vision-based methods that are limited to merchandise recognition. Specifically, embodiments use a seamless fusion of computer vision and REID to enable precision clustering of RFID-tagged merchandise items and associate them to a spatial domain (e.g., an image of a shelving unit) of a store.

Embodiments provide advantages over conventional planogram compliance solutions that do not include a multimodal framework or use machine learning techniques for planogram compliance inference with precision location understanding. For example, implementations of certain embodiments include self-learning to improve efficiency of planogram compliance as compared to conventional vision-based methods. Embodiments use a merchandise tracking model with machine learning techniques in order to learn from and make predictions on data. Such embodiments overcome following strictly static program instructions by making data-driven predictions or decisions regarding planogram compliance, through building a merchandise tracking model from an input self-learned planogram.

Embodiments provide advantages over conventional planogram compliance solutions that rely on deep learning. This is because deep learning not only requires significant amount of data, but also requires constant updating of a large training dataset in order to keep the performance up to date in response to ever-changing appearance of merchandise items.

Embodiments provide advantages over conventional RFID-based methods that use supervised machine learning. These conventional RFID-based methods also require constant training data collection in response to change in shelving unit locations. Beneficially, in contrast to traditional planogram compliance solutions, embodiments for automated planogram compliance using machine learning do not require recurring labor efforts to collect training datasets. Advantageously, this enables embodiments to be scalable by not requiring such recurring labor efforts.

Embodiments are also beneficially occlusion-free. For example, certain embodiments perform merchandise tracking using RFID tags and readers and computer vision to reinforce RFID merchandise tracking accuracy. By not relying solely on computer vision, these embodiments provide accurate location tracking for merchandise items that are occluded, or hidden from a camera's view. This results in a much more scalable planogram compliance solution. For instance, by using RFID for merchandise tracking that is reinforced by computer vision, embodiments enable tracking of many more items (e.g., tens of thousands of merchandise items) as compared to solely vision-based methods.

Embodiments are also beneficially more efficient and cost-effective than conventional planogram compliance solutions. This is because embodiments using machine learning techniques for planogram compliance inference with precision location understanding are fully automated and thus minimize the need for human intervention.

FIG. 2 is a block diagram and flowchart illustrating a planogram compliance system 200 configured to carry out a method for automated planogram compliance. In particular, FIG. 2 depicts a high-level system design and operations carried out by the planogram compliance system 200. As shown, the planogram compliance system 200 uses a self-learned planogram 202 as input to perform automated training 204. In some embodiments the self-learned planogram 202 may be created by a self-learning module, and the automated training 204 may be performed by an automated training module.

In some embodiments, a self-learning module is configured to perform the operations shown in FIG. 2 for creating the self-learned planogram 202. In FIG. 2, creating the self-learned planogram 202 includes using cameras 202a to capture image frames 202b. For example, the planogram compliance system 200 may begin operation by using top-down view cameras 202a to capture image frames 202b in order to create a panorama view of a store for shelving unit tracking 202c for a shelving unit. In certain embodiments, the image frames 202b may be any type of imagery, such as, for example, infrared (IR) images, x-ray images, or any other organized grid structure of imagery. For instance, the image frames 202b may include wireless signal density maps obtained from sensors on shelves of a shelving unit. Thus, the image frames 202h are not limited to camera images of the visible light spectrum or, even limited to the light spectrum. For example, at least some of the cameras 202a used to capture image frames 202b may include structured-light three-dimensional (3D) scanners that use a combination images from an IR camera and IR imaging. In some embodiments, a constructed grid arrangement with data gathered from an array of sensors disposed on the shelves of one or more shelving units at the location (e.g., shelves at a store) may be used to create at least some of the image frames 202b. For example, the cameras 202a used to capture the image frames 202b may include camera arrays (e.g., multi-camera arrays or a multi-camera system).

At operation 202d, a determination is made as to whether the location of the shelving unit has changed. If it is determined that there has been a location change, a stored planogram 202e is updated. If it is determined that there has not been a location change, then the stored planogram 202e is not updated. In embodiments, operation 202d may include determining if a configuration of shelves in the shelving unit has changed (e.g., locations of shelves within the shelving unit have changed). In this way, the self-learned planogram 202 is created and saved as the stored planogram 202e that includes the current location of the shelving unit. In a clothing store embodiment, the stored planogram 202e may resemble the example planogram discussed above with reference to FIG. 1.

With continued reference to FIG. 2., creation of the self-learned planogram 202 is followed by automated training 204. As shown, the automated training 204 includes using sensors 204a to capture sensor readings 204b. In certain embodiments, an automated training module is configured to perform the operations shown in FIG. 2 for performing the automated training 204. In the example of FIG. 2, the sensors 204a may include sensors with an integrated RFID reader and cameras (e.g., a pair of stereoscopic cameras). In additional or alternative embodiments, the sensors 204a may also include other sensors, such as, for example, global positioning system (GPS) sensors, an accelerometer, a gyroscope, a magnetometer (e.g., a magnetic field sensor), or a compass. According to additional or alternative embodiments, the sensors 204a may include sensors configured to capture sensor readings 204b from passive RFID tags. Such passive RFID tags may collect energy from interrogating radio waves transmitted from nearby RFID readers in the sensors 204a. These passive RFID tags may be affixed or attached to merchandise items (e.g., apparel or clothing items).

In certain embodiments, one or more of the sensors 204a may be implemented as an Intel® Responsive Retail Sensor (RRS) deployed at a store. For example, such sensors 204a may be deployed at locations in a store as part of an Intel® Responsive Retail Platform. According to these embodiments, each sensor 204a may comprise a motion sensor, a pair of stereoscopic cameras, an RFID reader, or other sensors. In these embodiments, each Intel® RRS sensor may include an RFID reader and be configured to upload its sensor readings to an off-site data store (e.g., cloud-based storage or an off-site database). In embodiments implemented using the Intel® Responsive Retail Platform, the platform will include a sensor hub configured to receive sensor readings from multiple RRS sensors. In some embodiments, the sensors 204a may include arbitrary RFID readers and 3D cameras, such as, for example, an Intel® RealSense camera. According to these non-limiting embodiments, the Intel® RealSense camera includes a conventional camera, an IR laser projector, an IR camera, and a microphone array. In additional or alternative embodiments, the sensors 204a may include a structured light camera instead of a stereoscopic camera.

As shown in FIG. 2, the sensors 204a may be used to capture sensor readings 204b, which may include images captured with sensor cameras and RFID readings captured with sensor RFID readers. For example, RFID data in sensor readings 204b may be combined with other sensor readings 204b, such as, for example, FR images, x-ray images, pixelated data, or video, to provide a cohesive near-real-time indication of merchandise location used to determine merchandise-shelving unit clustering 204c. In certain embodiments, the RFID readings may be used in conjunction with GPS readings to capture sensor readings 204b that include precise location information for merchandise items within a shelving unit. In some embodiments, the sensor readings 204b may also include sensor data indicative of the orientation of a merchandise item relative to a shelving unit. For example, sensor data associated with sensors such as an accelerometer, a gyroscope, a magnetometer, or a compass may be used to determine the movement and changes in orientation of a surface of a merchandise item the sensor is attached to relative to a respective vector (e.g., the floor of the store or a surface of the shelving unit).

In some embodiments, one or more of the sensors 204a may be devices configured to capture any type of imagery, such as, for example, IR, images, x-ray images, pixelated data, or any other organized grid structure of imagery. For instance, the sensor readings 204b may include wireless signal density maps captured by the sensors 204a sensors on shelves of a shelving unit. That is, the sensor readings 204b are not limited to RFID readings, GPS readings, and camera images of the visible light spectrum or, even limited to the light spectrum. For instance, at least some of the sensors 204a used to capture sensor readings 204b may include structured-light 3D scanners that use a combination images from an IR camera and IR imaging. In some embodiments, a constructed grid arrangement with data gathered from an array of sensors 204a disposed on the shelves of one or more shelving units at the location (e.g., store shelves) may be used to capture at least some of the sensor readings 204b. In certain embodiments, the sensors 204a used to capture the sensor readings 204b may include camera arrays (e.g., multi-camera arrays or a multi-camera system).

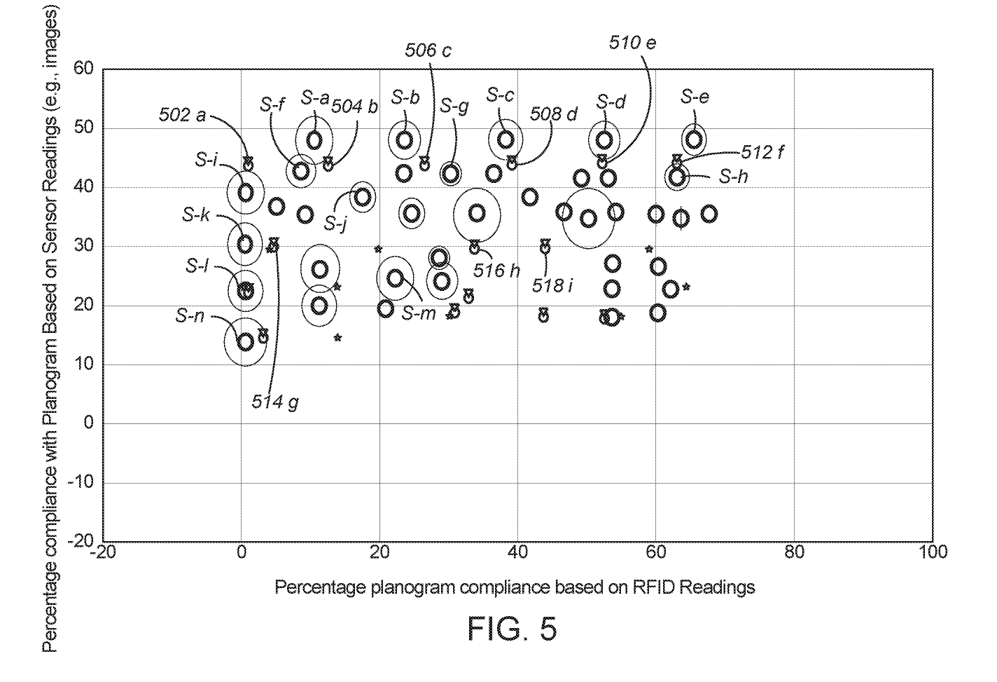

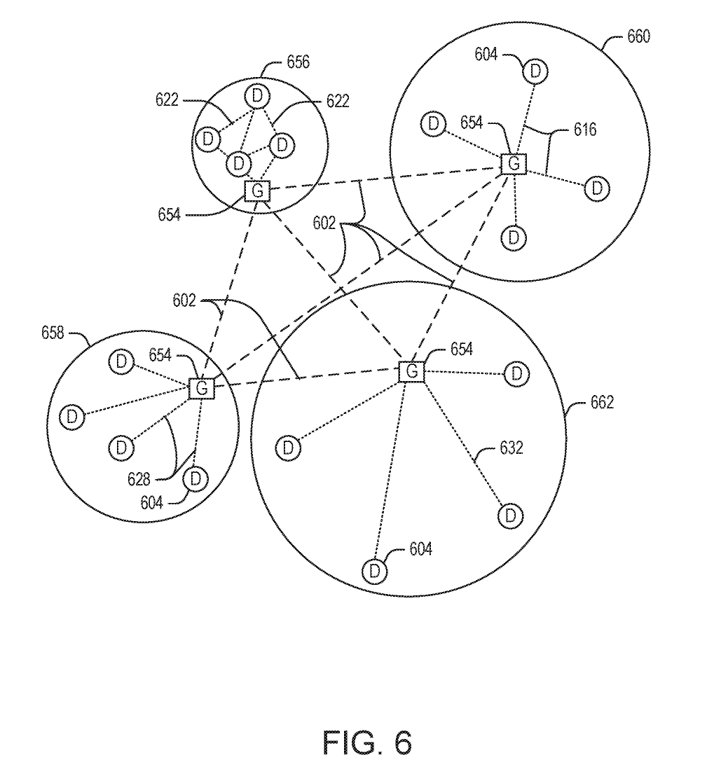

As shown in FIG. 2, the automated training 204 uses the sensor readings 204b to perform merchandise-shelving unit clustering 204c. The merchandise-shelving unit clustering 204c is based on comparing the desired shelving unit location in the planogram 202e to merchandise item locations indicated by the sensor readings 204b. For instance, the merchandise-shelving unit clustering 204c may identify locations for clusters of merchandise items (as indicated by sensor readings 204b) and compare those cluster locations to shelving unit locations in the stored planogram 202e. An example result of the merchandise-shelving unit clustering 204c is depicted in FIG. 5.

The automated training 204 includes online reinforcing RFID-based merchandise tracking by automatic retraining of a supervised learning model. In the example of FIG. 2, the supervised learning model is a merchandise tracking model 204e and the automatic retraining comprises updating the merchandise tracking model 204e by automatically performing merchandise tracking model training 204d.

By using the automated training 204, automated planogram compliance 206 may be performed. Based on the automated planogram compliance 206, actionable insights automation 208 may be performed so that a planogram compliance decision may be recommended to store operators (e.g., retailers). In certain embodiments the automated planogram compliance 206 may be performed by an automated planogram compliance module, and the actionable insights automation 208 may be performed by an actionable insights module. Components and steps for the automated planogram compliance 206 and the actionable insights automation 208 are described below with continued reference to FIG. 2.

In the example of FIG. 2, the automated planogram compliance 206 includes performing merchandise tracking 206a using sensor readings 204b and the merchandise tracking model 204e as inputs. In some embodiments, the merchandise tracking 206a may be performed using an item tracking module that is configured to track the physical locations of merchandise items based on the sensor readings 204b (e.g., RFID readings, pixelated data, camera images, video frames, and other sensor readings). The automated planogram compliance 206 also includes storing the results of the merchandise tracking 206a as merchandise locations 206b for the merchandise items being tracked. The merchandise locations 206b are then used as input to determine planogram compliance 206c results, where the results indicate whether certain merchandise items are out of stock (OoS), out of place, or at an insufficient inventory level (e.g., low inventory or inventory below a specified threshold). In some embodiments, an automated planogram compliance module is configured to perform the operations shown in FIG. 2 for determining and storing the planogram compliance 206c results. These planogram compliance 206c results are then used for actionable insights automation 208.

As shown in FIG. 2, the planogram compliance 206c results are stored in a planogram compliance database 208c, which is then used to perform planogram compliance-actionable insights analytics 208b, In some embodiments, the planogram compliance-actionable insights analytics 208b may be performed using an actionable insights module configured to carry out data analytics, using the planogram compliance 206c results, to determine whether there are any actionable insights to provide regarding merchandise items (e.g., OoS items, low inventory items, or out of place items). The planogram compliance-actionable insights analytics 208b identify whether there are any actionable insights that may be provided to a store operator (e.g., a retailer). For instance, a planogram compliance decision may be recommended to the store operator based on the planogram compliance-actionable insights analytics 208b results. The planogram compliance decision may be presented as a notification in a user interface or sent as a communication to the store operator. For example, the decision may be presented by performing operation 208a to notify retailers of a recommended planogram compliance decision, where the decision is based on the planogram compliance-actionable insights analytics 208b results.

In an embodiment, the planogram compliance system 200 may be implemented using an Intel® Responsive Retail Platform.

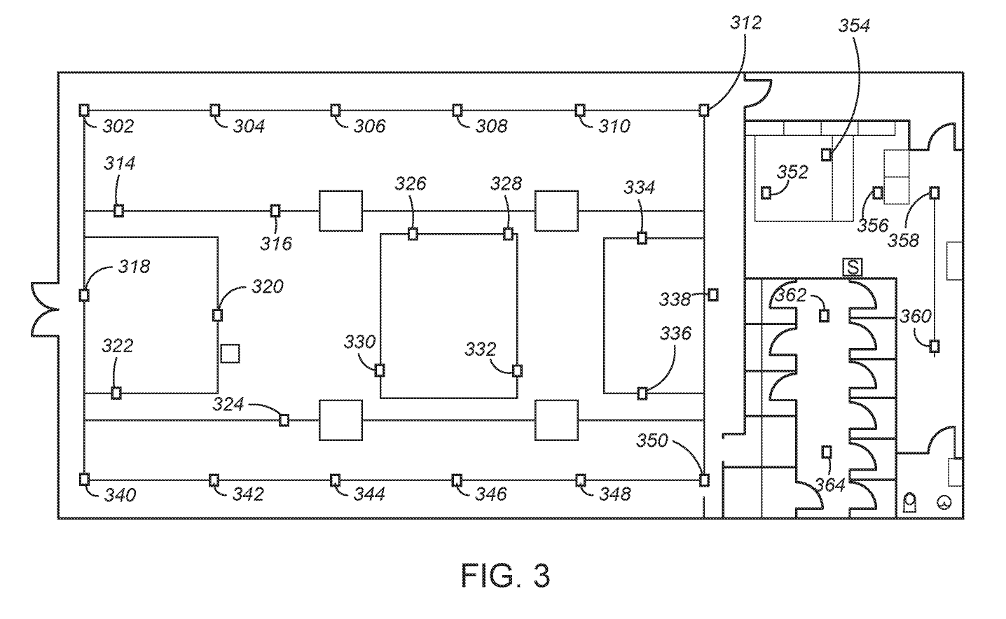

FIG. 3 depicts an example deployment of sensors at a store. The sensors, in an example embodiment, may be implemented as Intel® RRS sensors deployed at the store. For example, each sensor 302, 304, 306, 308, 310, 312, 314, 316, 318, 320, 322, 324, 326, 328, 330, 332, 334, 336, 338, 340, 342, 344, 346, 348, 350, 352, 354, 356, 358, 360, 362, and 364 may comprise a pair of stereoscopic cameras, an RFID reader, and other sensors. In such a deployment, there may be more than 7,000 apparel items with MD tags in the store.

As shown in FIG. 3, groups of sensors may be deployed within various sections, departments, or aisles of the store. For instance, sensors 318, 320, and 322 may be deployed in a section of the store near the entrance doors, sensors 302, 304, 306, 308, 310 are deployed in an aisle of the store to the left of the entrance doors, and sensors 340, 342, 344, 346, 348, and 350 are deployed in another aisle of the store to the right of the entrance doors. These groups of sensors may be used to track merchandise on shelving units in these different sections of the store.

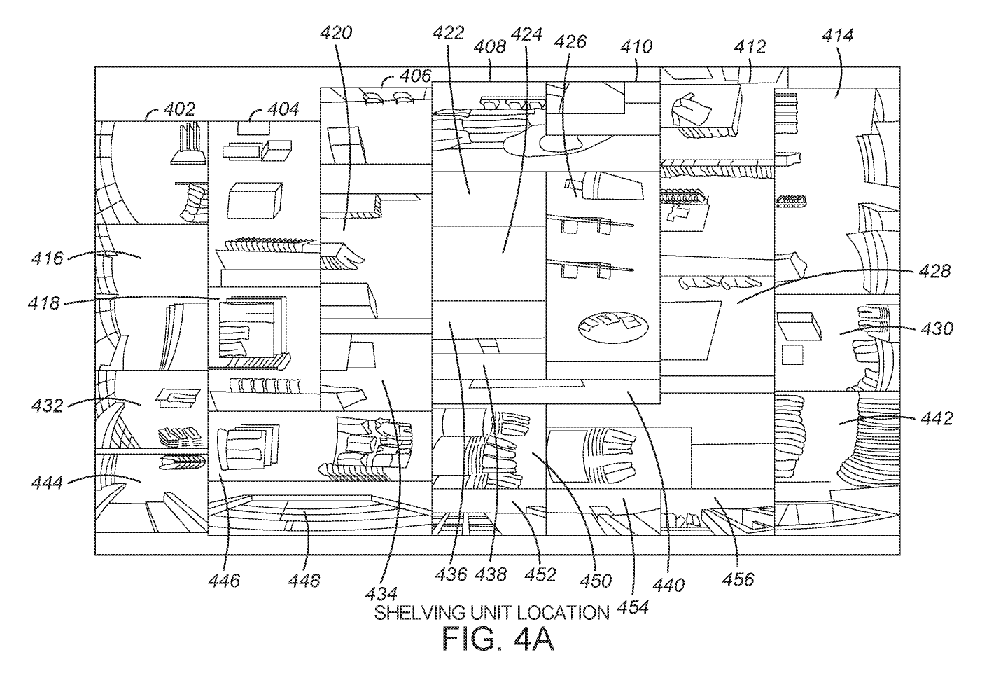

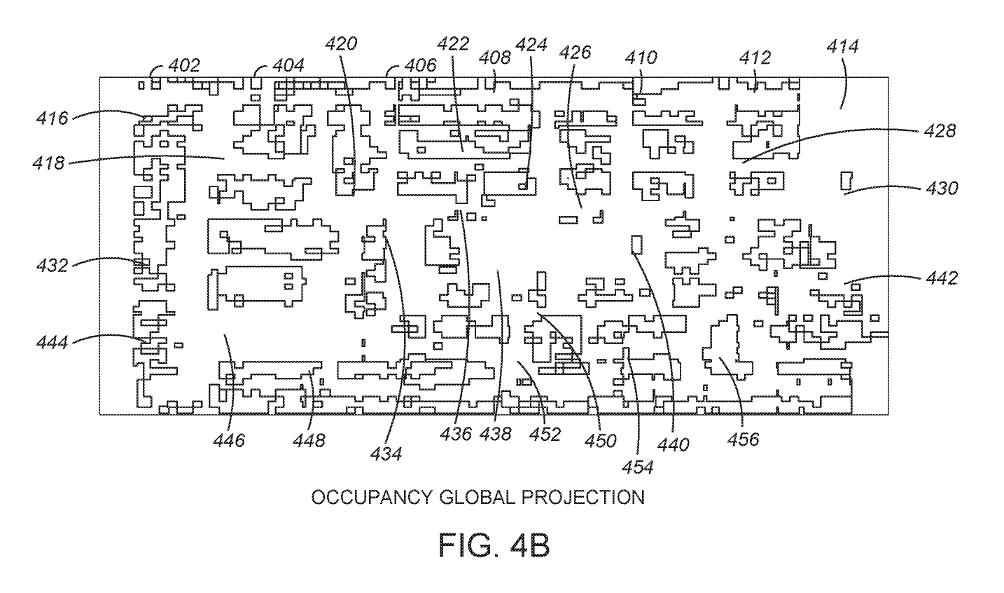

FIGS. 4A and 4B show example shelving unit tracking results. In particular, FIG. 4B depicts a panorama image with shelving unit locations within a shelving unit. As shown in FIG. 4A, the shelving unit locations include locations 402, 404, 406, 408, 410, 412, 414, 416, 418, 420, 422, 424, 426, 428, 430, 432, 434, 436, 438, 440, 442, 444, 446, 448, 450, 452, 454, and 456. The panorama image includes images of each of these locations captured by a camera. These images may be used together to form the store layout global projection depicted in FIG. 4A. As shown, the images indicate various merchandise items located at the locations.

FIG. 4B illustrates an occupancy global projection based on the image from FIG. 4A. With post-processing of smoothing and clustering on the occupancy global projection, a planogram may be inferred. As shown in FIG. 4B, the occupancy global projection depicts the locations 402, 404, 406, 408, 410, 412, 414, 416, 418, 420, 422, 424, 426, 428, 430, 432, 434, 436, 438, 440, 442, 444, 446, 448, 450, 452, 454, and 456 and indicates (using polygons) merchandise located at the locations 402-456.

FIG. 5 shows example merchandise clustering results. The results in FIG. 5 associate merchandise items to shelving units S-a, S-b, S-c, S-d, S-e, S-f, S-g, S-h, S-i, S-j, S-k, S-l, and S-n. In FIG. 5, the circles surrounding the shelving units S-a, S-b, S-c, S-d, S-e, S-f, S-g, S-h, S-i, S-j, S-k, S-l, and S-n represent clusters of merchandise items located at those shelving units. The merchandise clustering results as shown in FIG. 5 may serve as the training data for creating a supervised machine learning model to infer merchandise location. That is, the merchandise clustering results may be used to infer which shelving unit (S-a, S-b, and so on) a merchandise item is in based on sensor readings associated with merchandise items (e.g., a merchandise item's RFID reading). As shown, the sensor readings for merchandise items may be captured by sensors 502, 504, 506, 508, 510, 512, 514, 516, and 518. In the example of FIG. 5, the sensor readings include RFID readings and other sensor readings, such as, for example images captured by cameras). Sensor readings from sensors 502, 504, 506, 508, 510, 512, 514, 516, and 518 may be used to perform merchandise-shelving unit clustering in order to produce the merchandise clustering results shown in FIG. 5. For instance, the merchandise-shelving unit clustering may be based on comparing the desired shelving unit location in the planogram of FIG. 4A to clusters of merchandise item locations indicated by the sensor readings, as shown in FIG. 413. This merchandise-shelving unit clustering may be the merchandise-shelving unit clustering 204c discussed above with reference to FIG. 2. For example, the merchandise-shelving unit clustering may identify locations for clusters of merchandise items (as indicated by sensor readings from sensors 502, 504, 506, 508, 510, 512, 514, 516, and 518) and compare those cluster locations to shelving unit locations 402, 404, 406, 408, 410, 412, 414, 416, 418, 420, 422, 424, 426, 428, 430, 432, 434, 436, 438, 440, 442, 444, 446, 448, 450, 452, 454, and 456 in the planogram of FIG. 4A to plot the clusters of merchandise items shown in FIG. 5. In a non-limiting example, the sensors 502, 504, 506, 508, 510, 512, 514, 516, and 518 may be implemented as Intel® RRS sensors.

Merchandise clustering results such as those shown in FIG. 5 may be the merchandise-shelving unit clustering 204c of FIG. 2 and may be used as training data for merchandise tracking model training 204d, to create the merchandise tracking model 204e.

Such merchandise clustering results may be used for automated planogram compliance. For example, the planogram compliance takes as input shelving unit locations and merchandise locations and outputs planogram compliance issues, e.g., out of stock, out of place, low inventory, etc.

These planogram compliance issues may be output as part of actionable insights automation. For example, in some embodiments, planogram compliance issues may be sent to the cloud so that actionable insights may be generated and optimized in a way that minimizes the labor costs in order to resolve all compliance issues. Objectives for addressing planogram compliance issues may include restocking out of stock or low inventory merchandise items using the shortest routes, shortest turnaround time, lowest cost, or other objectives.

In certain embodiments, when deployed at a store, a self-learning planogram may be updated (or re-created) periodically depending on the frequency with which the retailer changes its planogram (e.g., weekly or monthly). Once a new planogram is determined, automated training may be performed using the components and steps described above with reference to FIG. 2. This automated training may be carried out in order to generate up-to-date models for merchandise tracking. Training a new model may be run overnight when the retailer is closed in cases where the training is time consuming due to, for example, a relatively large number of shelving units and merchandise items. Finally, in some embodiments, automated planogram compliance and actionable insights automation may be performed on the fly with the up-to-date planogram and merchandise tracking to reason about planogram compliance issues in real time.

### Example Internet-of-Things (IoT) Environments

FIG. 6 illustrates an example domain topology for respective internet-of-things (IoT) networks coupled through links to respective gateways. The internet of things (MT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet. For example, IoT devices may be used as the cameras 202a or sensors 204a discussed above with regard to FIG. 2. In particular, the networking of IoT devices shown in FIG. 6 may be used to capture the image frames 202b or pixelated data as sensor readings 204b discussed above with regard to FIG. 2.

Often, IoT devices are limited in memory, size, or functionality, allowing larger numbers to be deployed for a similar cost to smaller numbers of larger devices. However, an IoT device may be a smart phone, laptop, tablet, or or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

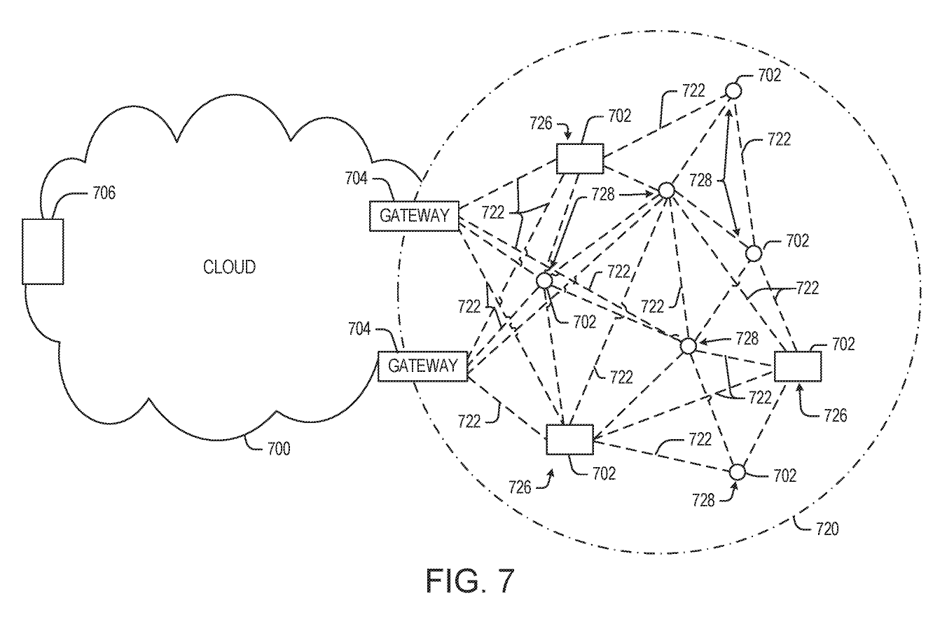

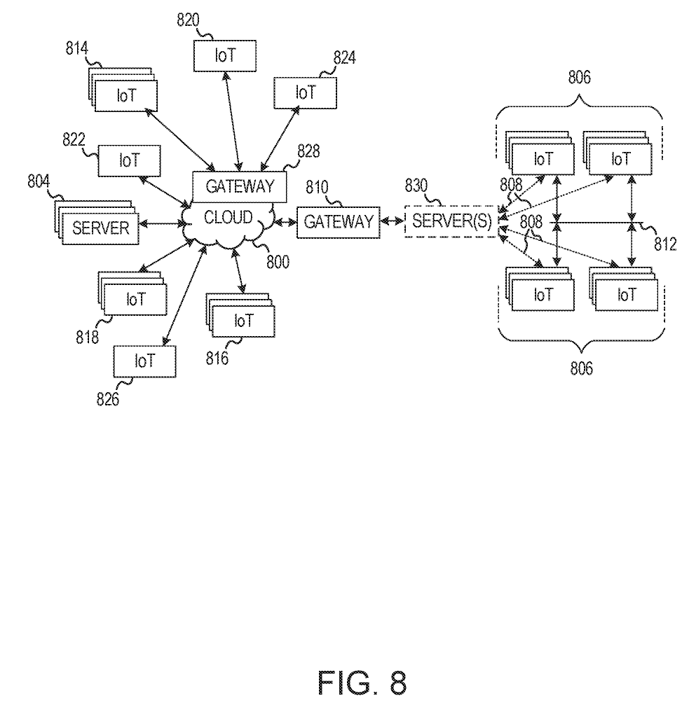

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 6 and 7, present a number of new challenges in a heterogeneous network of connectivity comprising a combination of wired and wireless technologies.

FIG. 6 specifically provides a simplified drawing of a domain topology that may be used for a number of internet-of-things (IoT) networks comprising IoT devices 604, with the IoT networks 656, 658, 660, 662, coupled through backbone links 602, to respective gateways 654. For example, a number of IoT devices 604 may communicate with a gateway 654, and with each other through the gateway 654. To simplify the drawing, not every IoT device 604, or communications link (e.g., link 616, 622, 628, or 632) is labeled. The backbone links 602 may include any number of wired or wireless technologies, including optical networks, and may be part of a local area network (LAN), a wide area network (WAN), or the Internet. Additionally, such communication links facilitate optical signal paths among both IoT devices 604 and gateways 654, including the use of MUXing/deMUXing components that facilitate interconnection of the various devices.

The network topology may include any number of types of IoT networks, such as a mesh network provided with the network 656 using Bluetooth low energy (BLE) links 622 Other types of IoT networks that may be present include a wireless local area network (WLAN) network 658 used to communicate with IoT devices 604 through IEEE 802.11 (Wi-Fi®) links 628, a cellular network 660 used to communicate with IoT devices 604 through an LTE/LTE-A (4G) or 5G cellular network, and a low-power wide area (LPWA) network 662, for example, a LPWA network compatible with the LoRaWan specification promulgated by the LoRa. alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internee application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

in an example, communications between IoT devices 604, such as over the backbone links 602, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 656, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 658, for instance, may use systems that perform standards conversion to provide multi-standard connectivity, enabling IoT devices 604 using different protocols to communicate. Further systems may provide seamless interconnectivity across a multi-standard infrastructure comprising visible Internet resources and hidden Internet resources,

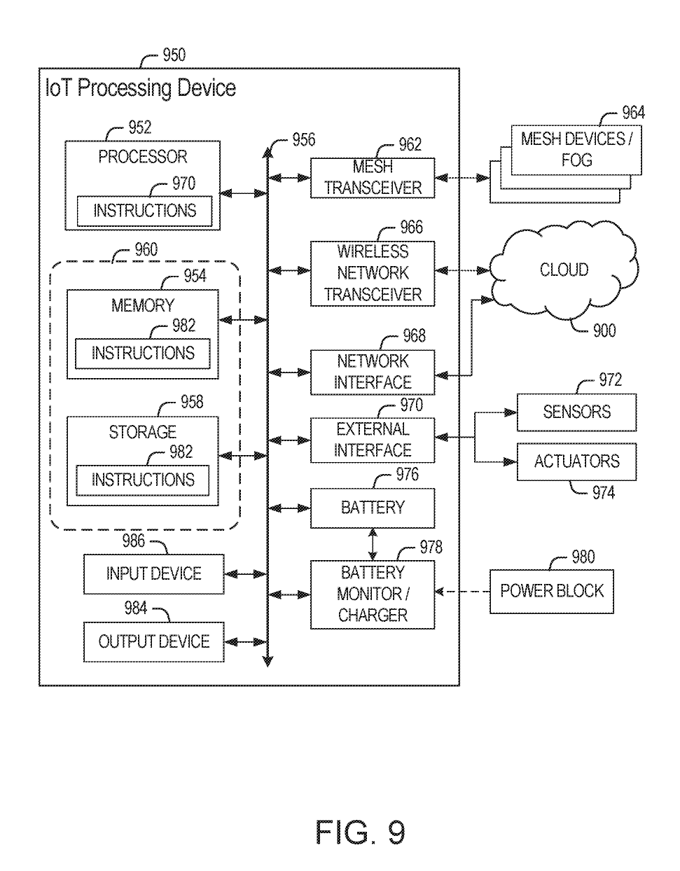

Communications in the cellular network 660, for instance, may be enhanced by systems that offload data, extend communications to more remote devices, or both. The LPWA network 662 may include systems that perform non-Internet protocol (IP) to IP interconnections, addressing, and routing. Further, each of the IoT devices 604 may include the appropriate transceiver for wide area communications with that device. Further, each IoT device 604 may include other transceivers for communications using additional protocols and frequencies. This is discussed further with respect to the communication environment and hardware of an IoT processing device depicted in FIGS. 8 and 9.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to :FIG. 7 below.

FIG. 7 illustrates a cloud computing network in communication with a mesh network of IoT devices (devices 702) operating as a fog device at the edge of the cloud computing network. The mesh network of IoT devices may be termed a fog 720, operating at the edge of the cloud 700. To simplify the diagram, not every IoT device 702 is labeled.

The fog 720 may be considered to be a massively interconnected network wherein a number of IoT devices 702 are in communications with each other, for example, by radio links 722. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 702, are shown in this example, gateways 704, data aggregators 726, and sensors 728, although any combinations of IoT devices 702 and functionality may be used. The gateways 704 may be edge devices that provide communications between the cloud 700 and the fog 720, and may also provide the backend process function for data obtained from sensors 728, such as motion data, flow data, temperature data, and the like. For instance, the sensors 204a discussed above with regard to FIG. 2 may be embodied as the sensors 728. In particular, the networking of the IoT devices 702 shown in FIG. 7 may be used to capture the image frames 202b or pixelated data as sensor readings 204b discussed above with regard to FIG.

The data aggregators 726 may collect data from any number of the sensors 728, and perform the back end processing function for the analysis. The results, raw data, or both may be passed along to the cloud 700 through the gateways 704. The sensors 728 may be full IoT devices 702, for example, capable of both collecting data and processing the data. In some cases, the sensors 728 may be more limited in functionality, for example, collecting the data and allowing the data aggregators 726 or gateways 704 to process the data.

Communications from any IoT device 702 may be passed along a convenient path (e.g.,, a most convenient path) between any of the IoT devices 702 to reach the gateways 704. In these networks, the number of interconnections provide substantial redundancy, allowing communications to be maintained, even with the loss of a number of IoT devices 702. Further, the use of a mesh network may allow IoT devices 702 that are very low power or located at a distance from infrastructure to be used, as the range to connect to another IoT device 702 may be much less than the range to connect to the gateways 704.

The fog 720 provided from these IoT devices 702 may be presented to devices in the cloud 700, such as a server 706, as a single device located at the edge of the cloud 700, e.g., a fog device. In this example, the alerts coming from the fog device may be sent without being identified as coming from a specific IoT device 702 within the fog 720. In this fashion, the fog 720 may be considered a distributed platform that provides computing and storage resources to perform processing or data-intensive tasks such as data analytics, data aggregation, and machine-learning, among others.

In some examples, the IoT devices 702 may be configured using an imperative programming style, e.g., with each IoT device 702 having a specific function and communication partners. However, the IoT devices 702 forming the fog device may be configured in a declarative programming style, allowing the IoT devices 702 to reconfigure their operations and communications, such as to determine needed resources in response to conditions, queries, and device failures. As an example, a query from a user located at a server 706 about the operations of a subset of equipment monitored by the IoT devices 702 may result in the fog 720 device selecting the devices 702, such as particular sensors 728, needed to answer the query. The data from these sensors 728 may then be aggregated and analyzed by any combination of the sensors 728, data aggregators 726, or gateways 704, before being sent on by the fog 720 device to the server 706 to answer the query. In this example, IoT devices 702 in the fog 720 may select the sensors 728 used based on the query, such as adding data from flow sensors or temperature sensors. Further, if some of the IoT devices 702 are not operational, other IoT devices 702 in the fog 720 device may provide analogous data, if available.

In other examples, the operations and functionality described above with reference to FIGS. 2-6 may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 8 illustrates a drawing of a cloud computing network, or cloud 800, in communication with a number of Internet of Things (IoT) devices. The cloud 800 may represent the Internet, or may be a local area network (LAN), or a wide area network (WAN), such as a proprietary network for a company. The IoT devices may include any number of different types of devices, grouped in various combinations. For example, a traffic control group 806 may include IoT devices along streets in a city. These IoT devices may include stoplights, traffic flow monitors, cameras, weather sensors, and the like. For example, the sensors 204a discussed above with regard to FIG. 2 may be embodied as the various IoT devices 814, 820, 824 shown in FIG. 8. In particular, the networking of the IoT devices 814, 820, 824 shown in FIG. 8 may be used to capture the image frames 202b or pixelated data as sensor readings 204b discussed above with regard to FIG, 2. Also, for instance, the networking of the IoT devices 814, 820, 824 shown in FIG. 8 may be used to capture the image frames 202b or pixelated data as sensor readings 204b discussed above with regard to FIG. 2.

The traffic control group 806, or other subgroups, may be in communication with the cloud 800 through wired or wireless links 808, such as LPWA links, optical links, and the like. For instance, the IoT devices 814, 820, 824 may upload their sensor readings to an off-site data store (e.g., the cloud 800). Further, a wired or wireless sub-network 812 may allow the IoT devices to communicate with each other, such as through a local area network, a wireless local area network, and the like. The IoT devices may use another device, such as a gateway 810 or 828 to communicate with remote locations such as the cloud 800; the IoT devices may also use one or more servers 830 to facilitate communication with the cloud 800 or with the gateway 810. For example, the one or more servers 830 may operate as an intermediate network node to support a local edge cloud or fog implementation among a local area network. Further, the gateway 828 that is depicted may operate in a cloud-to-gateway-to-many edge devices configuration, such as with the various IoT devices 814, 820, 824 being constrained or dynamic to an assignment and use of resources in the cloud 800.

Other example groups of IoT devices may include remote weather stations 814, local information terminals 816, alarm systems 818, automated teller machines 820, alarm panels 822, or moving vehicles, such as emergency vehicles 824 or other vehicles 826, among many others. Each of these IoT devices may be in communication with other IoT devices, with servers 804, with another IoT fog device or system (not shown, but depicted in FIG. 7), or a combination therein. The groups of IoT devices may be deployed in various residential, commercial, and industrial settings (including in both private or public environments),

As can be seen from FIG. 8, a large number of IoT devices may be communicating through the cloud 800. This may allow different IoT devices to request or provide information to other devices autonomously. For example, a group of IoT devices (e.g., the traffic control group 806) may request a current weather forecast from a group of remote weather stations 814, which may provide the forecast without human intervention. Further, an emergency vehicle 824 may be alerted by an automated teller machine 820 that a burglary is in progress. As the emergency vehicle 824 proceeds towards the automated teller machine 820, it may access the traffic control group 806 to request clearance to the location, for example, by lights turning red to block cross traffic at an intersection in sufficient time for the emergency vehicle 824 to have unimpeded access to the intersection.

Clusters of IoT devices, such as the remote weather stations 814 or the traffic control group 806, may be equipped to communicate with other IoT devices as well as with the cloud 800. This may allow the IoT devices to form an ad-hoc network between the devices, allowing them to function as a single device, which may be termed a fog device or system (e.g., as described above with reference to FIG. 7).

FIG. 9 is a block diagram of an example of components that may be present in an IoT device 950 for implementing the techniques described herein. The IoT device 950 may include any combinations of the components shown in the example or referenced in the disclosure above. The components may be implemented as ICs, portions thereof, discrete electronic devices, or other modules, logic, hardware, software, firmware, or a combination thereof adapted in the IoT device 950, or as components otherwise incorporated within a chassis of a larger system. Additionally, the block diagram of FIG. 9 is intended to depict a high-level view of components of the IoT device 950. However, some of the components shown may be omitted, additional components may be present, and different arrangement of the components shown may occur in other implementations.

The IoT device 950 may include a processor 952, which may be a microprocessor, a multi-core processor, a multithreaded processor, an ultra-low voltage processor, an embedded processor, or other known processing element. The processor 952 may be a part of a system on a chip (SoC) in which the processor 952 and other components are formed into a single integrated circuit, or a single package, such as the Edison™ or Galileo™ SoC boards from Intel. As an example, the processor 952 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcom® Technologies, Inc., or an OMAP™ processor from Texas Instruments, Inc.

The processor 952 may communicate with a system memory 954 over an interconnect 956 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 958 may also couple to the processor 952 via the interconnect 956. In an example the storage 958 may be implemented via a solid state disk drive (SSDD). Other devices that may be used for the storage 958 include flash memory cards, such as SD cards, microSD cards, xD picture cards, and the like, and USB flash drives. In low power implementations, the storage 9:58 may be on-die memory or registers associated with the processor 952. However, in some examples, the storage 958 may be implemented using a micro hard disk drive (HDD). Further, any number of new technologies may be used for the storage 958 in addition to, or instead of, the technologies described, such resistance change memories, phase change memories, holographic memories, or chemical memories, among others.

The components may communicate over the interconnect 956. The interconnect 956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in a SoC based system. Other bus systems may be included, such as an I2C interface, an SPI interface, point to point interfaces, and a power bus, among others.

The interconnect 956 may couple the processor 952 to a mesh transceiver 962, for communications with other mesh devices 964. The mesh transceiver 962 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 964. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 962 may communicate using multiple standards or radios for communications at different range. For example, the IoT device 950 may communicate with close devices, e.g., within about 9 meters, using a local transceiver based on BLE, or another low power radio, to save power. More distant mesh devices 964, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 966 may be included to communicate with devices or services in the cloud 900 via local or wide area network protocols. The wireless network transceiver 966 may be a LPWA transceiver that follows the IEEE 802.15.4, or IEEE 802.15.4g standards, among others. The IoT device 950 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4 e specification may be used.

Any number of other radio communications and protocols may be used in addition to the systems mentioned for the mesh transceiver 962 and wireless network transceiver 966, as described herein. For example, the radio transceivers 962 and 966 may include an LTE or other cellular transceiver that uses spread spectrum (SPA/SAS) communications for implementing high speed communications. Further, any number of other protocols may be used, such as Wi-Fi™ networks for medium speed communications and provision of network communications.

The radio transceivers 962 and 966 may include radios that are compatible with any number of 3GPP (Third Generation Partnership Project) specifications, notably Long Term Evolution (LTE), Long Term Evolution-Advanced (LTE-A), and Long Term Evolution-Advanced. Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (CPRS) radio communication technology, or an Enhanced Data Rates for GSM Evolution (EDGE) radio communication technology, a UMTS (Universal Mobile Telecommunications System) communication technology. In addition to the standards listed above, any number of satellite uplink technologies may be used for the wireless network transceiver 966, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

a network interface controller (NIC) 968 may be included to provide a wired communication to the cloud 900 or to other devices, such as the mesh devices 964. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 968 may be included to allow connect to a second network, for example, a NIC 968 providing communications to the cloud over Ethernet, and a second NIC 968 providing communications to other devices over another type of network,

The interconnect 956 may couple the processor 952 to an external interface 970 that is used to connect external devices or subsystems. The external devices may include sensors 972, such as accelerometers, level sensors, flow sensors, optical light sensors, camera sensors, temperature sensors, a global positioning system (GPS) sensors, pressure sensors, barometric pressure sensors, and the like. For example, the sensors 204a discussed above with regard to FIG. 2, may be embodied as the sensors 972 shown in FIG. 9. That is, the sensors 972 shown in FIG. 9 may be used to capture the image frames 202b or pixelated data as sensor readings 204b discussed above with regard to FIG. 2.

The external interface 970 further may be used to connect the IoT device 950 to actuators 974, such as power switches, valve actuators, an audible sound generator, a visual warning device, and the like.

In some optional examples, various input/output (I/O) devices may be present within, or connected to, the IoT device 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 950.

A battery 976 may power the IoT device 950, although in examples in which the IoT device 950 is mounted in a fixed location, it may have a power supply coupled to an electrical grid. The battery 976 may be a lithium ion battery, or a metal-air battery, such as a zinc-air battery, an aluminum-air battery, a lithium-air battery, and the like.

A battery monitor/charger 978 may be included in the IoT device 950 to track the state of charge (SoCh) of the battery 976. The battery monitor/charger 978 may be used to monitor other parameters of the battery 976 to provide failure predictions, such as the state of health (SoH) and the state of function (SoF) of the battery 976. The battery monitor/charger 978 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 978 may communicate the information on the battery 976 to the processor 952 over the interconnect 956. The battery monitor/charger 978 may also include an analog-to-digital (ADC) convertor that allows the processor 952 to directly monitor the voltage of the battery 976 or the current flow from the battery 976. The battery parameters may be used to determine actions that the IoT device 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the IoT device 950. A wireless battery charging circuit, such as an LTC4020 chip from Linear Technologies of Milpitas, Calif., among others, may be included in the battery monitor/charger 978. The specific charging circuits chosen depend on the size of the battery 976, and thus, the current required. The charging may be performed using the Airfuel standard promulgated by the Airfuel Alliance, the Q1 wireless charging standard promulgated by the Wireless Power Consortium, or the Rezence charging standard, promulgated by the Alliance for Wireless Power, among others.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application specific integrated circuit (ASIC).

In an example, the instructions 982 provided via the memory 954, the storage 958, or the processor 952 may be embodied as a non-transitory, machine readable medium 960 including code to direct the processor 952 to perform electronic operations in the IoT device 950. The processor 952 may access the non-transitory, machine readable medium 960 over the interconnect 956. For instance, the non-transitory, machine readable medium 960 may be embodied by devices described for the storage 958 of FIG. 9 or may include specific storage units such as optical disks, flash drives, or any number of other hardware devices. The non-transitory, machine readable medium 960 may include instructions to direct the processor 952 to perform a specific sequence or flow of actions, for example, as described with respect to the flowchart(s) and block diagram(s) of operations and functionality depicted above.

### Example Computer System Implementations:

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms, Modules may be hardware, software, or firmware communicatively coupled to one or more processors in order to carry out the operations described herein. For example, the self-learning module, the automated training module, the automated planogram compliance module, the actionable insights module, and the item tracking module described above with reference to FIG. 2 may be implemented as hardware, software, or firmware. Modules may be hardware modules, and as such, modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term “hardware module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

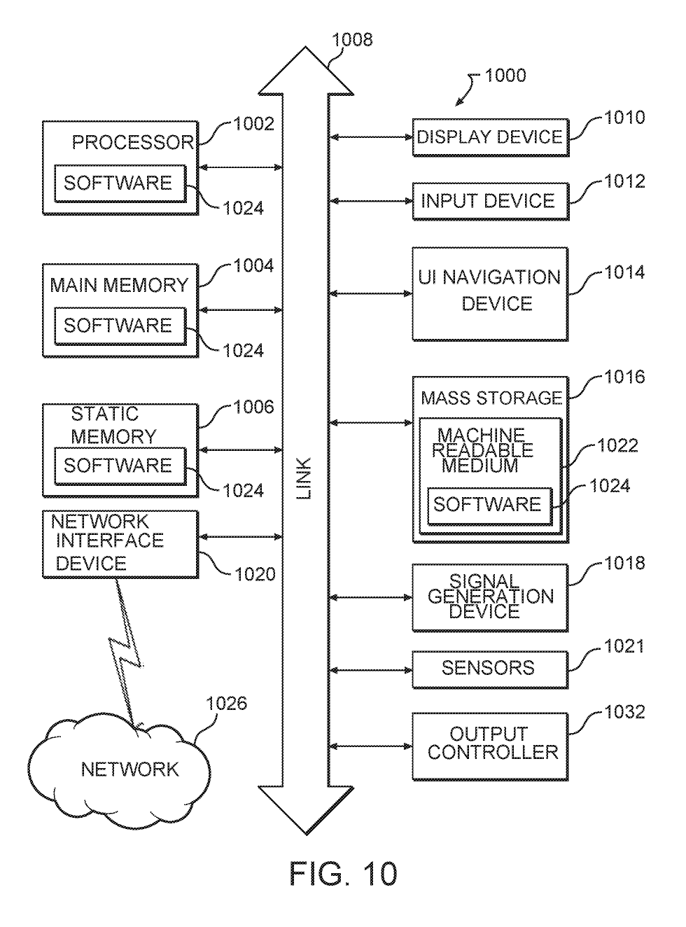

FIG. 10 is a block diagram illustrating a machine in the example form of a computer system 1000, within which a set or sequence of instructions may be executed to cause the machine to perform any one of the methodologies discussed herein, according to an example embodiment. For example, the method described above with reference to FIG. 2 may be performed using the computer system 1000.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, an ADAS, an apparatus of an autonomous driving vehicle, a wearable device, a personal computer (PC), a tablet PC, a hybrid tablet, a personal digital assistant (PDA), a mobile telephone (e.g., a smartphone), or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor e.g., a computer) to individually or jointly execute instructions to perform any one or more of the methodologies discussed herein. For instance, the computer system 1000 may execute instructions to perform the method described above with reference to FIG. 2.

Example computer system 1000 includes at least one processor 1002 (e.g., a central processing unit (CPU), a graphics processing unit (CPU) or both, processor cores, compute nodes, etc.), a main memory 1004 and a static memory 1006, which communicate with each other via a link 1008 (e.g., bus). The computer system 1000 may further include a video display device 1010, an input device 1012 (e.g., an alphanumeric input device such as keyboard or keypad, a touchpad, a microphone, a camera, or components of a virtual reality/VR headset such as buttons), and a user interface (UI) navigation device 1014 (e.g., a mouse, a stylus, or a pointing device). In one embodiment, the video display device 1010, input device 1012 and UI navigation device 1014 are incorporated into a touch screen display (e.g., a touch sensitive display device). In some embodiments, user interfaces to present the planogram and the occupancy projection described above with reference to FIGS. 4A and 4B may be displayed on the video display device 1010. In certain embodiments, the actionable insights described above with reference to FIG. 2 may be presented on the video display device 1010.

The computer system 1000 may additionally include a storage device 1016 (e.g., a drive unit), a signal generation device 1018 (e.g., a speaker), a network interface device 1020, and one or more sensors 1021, such as an RFID reader, a global positioning system (GPS) sensor, a camera, a compass, an accelerometer, a pyrometer, a magnetometer, or other sensors. The computer system 1000 may also include an output controller 1032, such as a serial (e.g., universal serial bus (USB), parallel, or other wired or wireless (e.g., IR, near field communication (NFC), etc.) connection to communicate or control one or more peripheral devices (e.g., a printer, card reader, etc.). In some embodiments, the processor 1002 and/or instructions 1024 (e.g., software in the example shown in FIG. 10) comprises processing circuitry and/or transceiver circuitry.

The storage device 1016 includes a machine-readable medium 1022 on which is stored one or more sets of data structures and instructions 1024 (e.g., software) embodying or utilized by any one or more of the methodologies or functions described herein. For example, the computer system 1000 may execute instructions 1024 to perform the method described above with reference to FIG. 2.

The instructions 1024 may also reside, completely or at least partially, within the main memory 1004, static memory 1006, and/or within the processor 1002 during execution thereof by the computer system 1000, with the main memory 1004, static memory 1006, and the processor 1002 also constituting machine-readable media 1022.

While the machine-readable medium 1022 is illustrated in an example embodiment to be a single medium, the term “machine-readable medium” may include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions 1024 for execution by the machine and that cause the machine to perform any one or more of the methodologies of the present disclosure or that is capable of storing, encoding or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, 3G, and 4G LTE/LTE-A or WiMAX networks). The network interface device 1020 may transmit and receive data over a transmission medium, which may be wired or wireless (e.g., radio frequency, infrared or visible light spectra, etc.), fiber optics, or the like, to network 1026.

Network interface device 1020, according to various embodiments, may take any suitable form factor. In one such embodiment, network interface device 1020 is in the form of a network interface card (NIC) that interfaces with processor 1002, via link 1008. In one example, link 1008 includes a PCI Express (PCIe) bus, including a slot into which the NIC form-factor may removably engage. In another embodiment, network interface device 1020 is a network interface circuit laid out on a motherboard together with local link circuitry, processor interface circuitry, other input/output circuitry, memory circuitry, storage device and peripheral controller circuitry, and the like. In another embodiment, network interface device 1020 is a peripheral that interfaces with link 1008 via a peripheral input/output port such as a universal serial bus (USB) port.

### EXAMPLES

Example 1 is a planogram compliance system for automating planogram compliance based on a merchandise tracking model, the system comprising: a self-learning module for creating a self-learned planogram based on images of a plurality of shelving units at a location and shelving unit tracking, the self-learned planogram including shelving unit locations for one or more of the plurality of shelving units; an automated training module for training the merchandise tracking model based on merchandise-shelving unit clustering, the merchandise-shelving unit clustering being based on the self-learned planogram and sensor readings received from a plurality of sensors at the location, the sensor readings being associated with a plurality of items at the location; an item tracking module for tracking and storing respective locations of the plurality of items based on the sensor readings and the merchandise tracking model; an automated planogram compliance module for determining planogram compliance results based on comparing the self-learned planogram to the stored respective locations of the plurality of items; an actionable insights module for identifying actionable insights based on the planogram compliance results; and a display device to present the actionable insights.

In Example 2, the subject matter of Example 1 includes, wherein, the location is a store, and wherein the items include merchandise items offered for sale at the store.

In Example 3, the subject matter of Example 2 includes, wherein each of the plurality of sensors are associated with a respective shelving unit location in the one or more of the plurality of shelving units, and wherein the sensor readings indicate respective locations of merchandise items offered for sale at the store.

In Example 4, the subject matter of Examples 1-3 includes, wherein each of the plurality of sensors includes a pair of stereoscopic cameras and a radio-frequency identification (RFID) reader.

In Example 5, the subject matter of Example 4 includes, wherein each of the plurality of sensors further includes one or more of a structured-light three-dimensional (3D) scanner, an infrared (IR) camera, a camera array, a motion sensor, a global positioning system (GPS) sensor, an accelerometer, a gyroscope, a magnetometer, and a compass, and wherein the images include one or more of IR images, x-ray images, pixelated data, or any other organized grid structure of imagery.

In Example 6, the subject matter of Examples 1-5 includes, wherein the actionable insights module further identifies the actionable insights based on planogram compliance-actionable insights analytics.

In Example 7, the subject matter of Examples 1-6 includes, wherein the actionable insights module stores the identified actionable insights in a planogram compliance database.

In Example 8, the subject matter of Examples 1-7 includes, wherein the actionable insights indicate whether respective ones of the plurality of items are out of stock at the location, out of place at the location, or below a specified threshold inventory at the location.

In Example 9, the subject matter of Examples 1-8 includes, wherein the self-learning module receives the images of the plurality of shelving units as image frames from one or more cameras at the location.

In Example 10, the subject matter of Example 9 includes, wherein the self-learning module updates the self-learned planogram based on detecting, based on using the image frames to update the shelving unit tracking, a change to a shelving unit location for one or more of the plurality of shelving units.

Example 11 is a method for automating planogram compliance based on a merchandise tracking model, the method comprising: creating a self-learned planogram based on images of a plurality of shelving units at a location and shelving unit tracking, the self-learned planogram including shelving unit locations for one or more of the plurality of shelving units; training the merchandise tracking model based on merchandise-shelving unit clustering, the merchandise-shelving unit clustering being based on the self-learned planogram and sensor readings received from a plurality of sensors at the location, the sensor readings being associated with a plurality of items at the location; tracking and storing respective locations of the plurality of items based on the sensor readings and the merchandise tracking model; determining planogram compliance results based on comparing the self-learned planogram to the stored respective locations of the plurality of items; identifying actionable insights based on the determined planogram compliance results; and presenting the actionable insights to a user.

In Example 12, the subject matter of Example 11 includes, wherein, the location is a store, and wherein the items include merchandise items offered for sale at the store.

In Example 13, the subject matter of Example 12 includes, wherein each of the plurality of sensors are associated with a respective shelving unit location in the one or more of the plurality of shelving units, and wherein the sensor readings indicate respective locations of merchandise items offered for sale at the store.

In Example 14, the subject matter of Example 13 includes, wherein each of the plurality of sensors includes a pair of stereoscopic cameras and a radio-frequency identification (RFID) reader.

In Example 15, the subject matter of Example 14 includes, wherein each of the plurality of sensors further includes one or more of a structured-light three-dimensional (3D) scanner, an infrared (IR) camera, a camera array, a motion sensor, a global positioning system (GPS) sensor, an accelerometer, a gyroscope, a magnetometer, and a compass, and wherein the images include one or more of IR images, x-ray images, pixelated data; or any other organized grid structure of imagery.

In Example 16, the subject matter of Examples 11-15 includes, wherein identifying the actionable insights comprises identifying the actionable insights based on planogram compliance-actionable insights analytics.

In Example 17, the subject matter of Examples 11-16 includes, wherein identifying the actionable insights comprises storing the identified actionable insights in a planogram compliance database.

In Example 18, the subject matter of Examples 11-17 includes, wherein the actionable insights indicate whether respective ones of the plurality of items are out of stock at the location, out of place at the location, or below a specified threshold inventory at the location.

In Example 19, the subject matter of Examples 11-18 includes, wherein creating the self-learned planogram comprises receiving the images of the plurality of shelving units as image frames from one or more cameras at the location.

In Example 20, the subject matter of Example 19 includes, updating the self-learned planogram in response to detecting, based on using the image frames to update the shelving unit tracking, a change to a shelving unit location for one or more of the plurality of shelving units.

Example 21 is at least one machine-readable medium including instructions, which when executed by a machine, cause the machine to perform operations of any of the methods of Examples 11-20.

Example 22 is an apparatus comprising means for performing any of the methods of Examples 11-20.

Example 23 is at least one machine-readable medium including instructions, which when executed by a machine, cause the machine to: create a self-learned planogram based on images of a plurality of shelving units at a location and shelving unit tracking, the self-learned planogram including shelving unit locations for one or more of the plurality of shelving units; train the merchandise tracking model based on merchandise-shelving unit clustering, the merchandise-shelving unit clustering being based on the self-learned planogram and sensor readings received from a plurality of sensors at the location, the sensor readings being associated with a plurality of items at the location; track and store respective locations of the plurality of items based on the sensor readings and the merchandise tracking model; determine planogram compliance results based on comparing the self-learned planogram to the stored respective locations of the plurality of items; identify actionable insights based on the determined planogram compliance results; and present the actionable insights to a user.

In Example 24, the subject matter of Example 23 includes, wherein, the location is a store, and wherein the items include merchandise items offered for sale at the store.

In Example 25, the subject matter of Example 24 includes, wherein each of the plurality of sensors are associated with a respective shelving unit location in the one or more of the plurality of shelving units, and wherein the sensor readings indicate respective locations of merchandise items offered for sale at the store.

In Example 26, the subject matter of Examples 23-25 includes, wherein the images include one or more of infrared (IR) images, x-ray images, pixelated data, or any other organized grid structure of imagery.

In Example 27, the subject matter of Examples 23-26 includes, wherein each of the plurality of sensors includes a pair of stereoscopic cameras and a radio-frequency identification (RFID) reader.

In Example 28, the subject matter of Example 27 includes, wherein each of the plurality of sensors further includes one or more of a structured-light three-dimensional (3D) scanner, an infrared (IR) camera, a camera array, a motion sensor, a global positioning system (GPS) sensor, an accelerometer, a gyroscope, a magnetometer, and a compass.

In Example 29, the subject matter of Examples 23-28 includes, wherein identifying the actionable insights comprises identifying the actionable insights based on planogram compliance-actionable insights analytics.

In Example 30, the subject matter of Examples 23-29 includes, wherein identifying the actionable insights comprises storing the identified actionable insights in a planogram compliance database.

In Example 31, the subject matter of Examples 23-30 includes, wherein the actionable insights indicate whether respective ones of the plurality of items are out of stock at the location, out of place at the location, or below a specified threshold inventory at the location.

Example 32 is an apparatus for automating planogram compliance based on a merchandise tracking model, the apparatus comprising: means for creating a self-learned planogram based on images of a plurality of shelving units at a location and shelving unit tracking, the self-learned planogram including shelving unit locations for one or more of the plurality of shelving units; means for training the merchandise tracking model based on merchandise-shelving unit clustering, the merchandise-shelving unit clustering being based on the self-learned planogram and sensor readings received from a plurality of sensors at the location, the sensor readings being associated with a plurality of items at the location; means for tracking and storing respective locations of the plurality of items based on the sensor readings and the merchandise tracking model; means for determining planogram compliance results based on comparing the self-learned planogram to the stored respective locations of the plurality of items; means for identifying actionable insights based on the determined planogram compliance results; and means for presenting the actionable insights to a user.

In Example33, the subject matter of Example 32 includes, wherein, the location is a store, and wherein the items include merchandise items offered for sale at the store.

In Example 34, the subject matter of Example 33 includes, wherein each of the plurality of sensors are associated with a respective shelving unit location in the one or more of the plurality of shelving units, and wherein the sensor readings indicate respective locations of merchandise items offered for sale at the store.

In Example 35, the subject matter of Examples 32-34 includes, wherein the images include one or more of infrared (IR) images, x-ray images, pixelated data, or any other organized grid structure of imagery.

In Example 36, the subject matter of Examples 32-35 includes, wherein each of the plurality of sensors includes a pair of stereoscopic cameras and a radio-frequency identification (MID) reader,

In Example 37, the subject matter of Example 36 includes, wherein each of the plurality of sensors further includes one or more of a structured-light three-dimensional (3D) scanner, an infrared (IR) camera, a camera array, a motion sensor, a global positioning system (GPS) sensor, an accelerometer, a gyroscope, a magnetometer, and a compass.

In Example 38, the subject matter of Examples 32-37 includes, wherein the means for identifying the actionable insights comprises means for identifying the actionable insights based on planogram compliance-actionable insights analytics.

In Example 39, the subject matter of Examples 32-38 includes, wherein the means for identifying the actionable insights comprises means for storing the identified actionable insights in a planogram compliance database.

In Example 40, the subject matter of Examples 32-39 includes, wherein the actionable insights indicate whether respective ones of the plurality of items are out of stock at the location, out of place at the location, or below a specified threshold inventory at the location.

In Example 41, the subject matter of Examples 32-40 includes, wherein the means for creating the self-learned planogram comprises means for receiving the images of the plurality of shelving units as image frames from one or more cameras at the location.

In Example 42, the subject matter of Example 41 includes, means for updating the self-learned planogram in response to detecting, based on using the image frames to update the shelving unit tracking, a change to a shelving unit location for one or more of the plurality of shelving units.

Example 43 is at least one machine-readable medium including instructions, which when executed by a machine, cause the machine to perform operations of any of the operations of Examples 1-42.

Example 44 is an apparatus comprising means for performing any of the operations of Examples 1-42.

Example 45 is a system to perform the operations of any of Examples 1-42.

Example 46 is a method to perform the operations of any of Examples 1-42.

### Additional Notes:

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A planogram compliance system for automating planogram compliance based on a merchandise tracking model, the system comprising:
a self-learning module for creating a self-learned planogram based on images of a plurality of shelving units at a location and shelving unit tracking, the self-learned planogram including shelving unit locations for one or more of the plurality of shelving units;
an automated training module for training the merchandise tracking model based on merchandise-shelving unit clustering, the merchandise-shelving unit clustering being based on the self-learned planogram and sensor readings received from a plurality of sensors at the location, the sensor readings being associated with a plurality of items at the location;
an item tracking module for tracking and storing respective locations of the plurality of items based on the sensor readings and the merchandise tracking model;
an automated planogram compliance module for determining planogram compliance results based on comparing the self-learned planogram to the stored respective locations of the plurality of items;
an actionable insights module for identifying actionable insights based on the planogram compliance results; and
a display device to present the actionable insights.

2. The system of claim 1, wherein, the location is a store, and wherein the items include merchandise items offered for sale at the store.

3. The system of claim 2, wherein each of the plurality of sensors are associated with a respective shelving unit location in the one or more of the plurality of shelving units, and wherein the sensor readings indicate respective locations of merchandise items offered for sale at the store.

4. The system of claim 1, wherein each of the plurality of sensors includes a pair of stereoscopic cameras and a radio-frequency identification (RFID) reader.

5. The system of claim 4, wherein each of the plurality of sensors further includes one or more of a structured-light three-dimensional (3D) scanner, an infrared (IR) camera, a camera array, a motion sensor, a global positioning system (GPS) sensor, an accelerometer, a gyroscope, a magnetometer, and a compass, and wherein the images include one or more of IR images, x-ray images, pixelated data, or any other organized grid structure of imagery.

6. The system of claim 1, wherein the actionable insights module further identifies the actionable insights based on planogram compliance-actionable insights analytics.

7. The system of claim 1, wherein the actionable insights module stores the identified actionable insights in a planogram compliance database.

8. The system of claim 1, wherein the actionable insights indicate whether respective ones of the plurality of items are out of stock at the location, out of place at the location, or below a specified threshold inventory at the location.

9. The system of claim 1, wherein the self-learning module receives the images of the plurality of shelving units as image frames from one or more cameras at the location.

10. The system of claim 9, wherein the self-learning module updates the self-learned planogram based on detecting, based on using the image frames to update the shelving unit tracking, a change to a shelving unit location for one or more of the plurality of shelving units,

11. A method for automating planogram compliance based on a merchandise tracking model, the method comprising:
creating a self-learned planogram based on images of a plurality of shelving units at a location and shelving unit tracking, the self-learned planogram including shelving unit locations for one or more of the plurality of shelving units;
training the merchandise tracking model based on merchandise-shelving unit clustering, the merchandise-shelving unit clustering being based on the self-learned planogram and sensor readings received from a plurality of sensors at the location, the sensor readings being associated with a plurality of items at the location;
tracking and storing respective locations of the plurality of items based on the sensor readings and the merchandise tracking model;
determining planogram compliance results based on comparing the self-learned planogram to the stored respective locations of the plurality of items;
identifying actionable insights based on the determined planogram compliance results; and
presenting the actionable insights to a user.

12. The method of claim 11, wherein, the location is a store, and wherein the items include merchandise items offered for sale at the store.

13. The method of claim 12, wherein each of the plurality of sensors are associated with a respective shelving unit location in the one or more of the plurality of shelving units, and wherein the sensor readings indicate respective locations of merchandise items offered for sale at the store.

14. The method of claim 11, wherein each of the plurality of sensors includes a pair of stereoscopic cameras and a radio-frequency identification (RFID) reader.

15. The method of claim 14, wherein each of the plurality of sensors further includes one or more of a structured-light three-dimensional (3D) scanner, an infrared (IR) camera, a camera array, a motion sensor, a global positioning system (GPS) sensor, an accelerometer, a gyroscope, a magnetometer, and a compass, and wherein the images include one or more of IR images, x-ray images, pixelated data, or any other organized grid structure of imagery.

16. The method of claim 11, wherein the actionable insights indicate whether respective ones of the plurality of items are out of stock at the location, out of place at the location, or below a specified threshold inventory at the location.

17. The method of claim 11, wherein creating the self-learned planogram comprises receiving the images of the plurality of shelving units as image frames from one or more cameras at the location.

18. The method of claim 17, further comprising:
updating the self-learned planogram in response to detecting, based on using the image frames to update the shelving unit tracking, a change to a shelving unit location for one or more of the plurality of shelving units.

19. At least one non-transitory machine-readable medium including instructions, which when executed by a machine, cause the machine to:
create a self-learned planogram based on images of a plurality of shelving units at a location and shelving unit tracking, the self-learned planogram including shelving unit locations for one or more of the plurality of shelving units;
train the merchandise tracking model based on merchandise-shelving unit clustering, the merchandise-shelving unit clustering being based on the self-learned planogram and sensor readings received from a plurality of sensors at the location, the sensor readings being associated with a plurality of items at the location;
track and store respective locations of the plurality of items based on the sensor readings and the merchandise tracking model;
determine planogram compliance results based on comparing the self-learned planogram to the stored respective locations of the plurality of items;
identify actionable insights based on the determined planogram compliance results; and
present the actionable insights to a user.

20. The at least one machine-readable medium of claim 19, wherein, the location is a store, and wherein the items include merchandise items offered for sale at the store.

21. The at least one machine-readable medium of claim 20, wherein each of the plurality of sensors are associated with a respective shelving unit location in the one or more of the plurality of shelving units, and wherein the sensor readings indicate respective locations of merchandise items offered for sale at the store.

22. The at least one machine-readable medium of claim 19, wherein the images include one or more of infrared (IR) images, x-ray images, pixelated data, or any other organized grid structure of imagery.

23. The at least one machine-readable medium of claim 19, wherein each of the plurality of sensors includes a pair of stereoscopic cameras and a radio-frequency identification (REID) reader.

24. The at least one machine-readable medium of claim 23, wherein each of the plurality of sensors further includes one or more of a structured-light three-dimensional (3D) scanner, an infrared (IR) camera, a camera array, a motion sensor, a global positioning system (GPS) sensor, an accelerometer, a gyroscope, a magnetometer, and a compass.

25. The at least one machine-readable medium of claim 19, wherein the actionable insights indicate whether respective ones of the plurality of items are out of stock at the location, out of place at the location, or below a specified threshold inventory at the location.
